(19) United States
(12) Patent Application Publication
(10) Pub. No.: US 2020/0360224 A1
(43) Pub. Date: Nov. 19, 2020

(54) INFLATABLE COMPRESSION SLEEVE

(71) Applicant: MEGO AFEK AC LTD., Kibbutz Afek (IL)

(72) Inventor: Asher BEN-NOON, Carmiel (IL)

(21) Appl. No.: 16/963,449

(22) PCT Filed: Jan. 23, 2019
(86) PCT No.: PCT/IL2019/050091

§ 371 Date: Jul. 20, 2020

Related U.S. Application Data
(60) Provisional application No. 62/623,000, filed on Jan. 29, 2018.

(51) Int. Cl. A61H 9/00

(52) U.S. Cl. CPC A61H 9/0092; A61H 2205/06; A61H 2201/1654; A61H 2201/165; A61H 2205/10

(57) ABSTRACT

An inflatable compression sleeve for performing compression therapy on a limb of a subject, the compression sleeve including a plurality of inflatable pockets, each extending substantially transversely; wherein each of the pockets is adjacent to at least one other pocket; wherein each of the pockets has a first airtight wall, a second airtight wall opposite to the first airtight wall, and an air inlet, wherein each of the second airtight walls is adjacent to the limb when the compression sleeve is wrapped about the limb; and wherein at least one of the pockets is fingered, including a pocket extension projecting substantially longitudinally from a pocket main portion of the respective pocket, the pocket extension including the air inlet.

### FIELD OF THE INVENTION

The invention, in some embodiments thereof, relates to inflatable compression sleeves for use in pneumatic compression therapy.

### BACKGROUND

Deep vein thrombosis (DVT) is a serious and potentially life-threatening disorder. The physiological cause of this disorder is lack of adequate blood circulation in the extremities, particularly in the lower extremities, but in some cases in the upper extremities, e.g. in the upper arm following breast cancer removal surgery. The lack of movement of venous blood can cause clots to form, which may cause blockages in the local blood vessels, or in more serious situations, may lodge in the lungs or heart and cause critical blockages which can be life-threatening.

A large number of studies have shown that DVT can be prevented by enhancing or accelerating the return of venous blood from the extremities. A common and accepted method for accelerating venous blood return from the limbs is pneumatic compression, e.g. applied to the sole of the foot and/or the calf muscle of the leg. This form of treatment is commonly referred to as “compression therapy”, and is performed using a compression device, which feeds compressed air to a garment or “sleeve” containing one or more cells which inflate and deflate, alternately applying and releasing pressure to the extremities of the patient.

In hospitals there are many devices of this kind, and there are compression therapy usage protocols for patients who are hospitalized for operative procedures or have other risk factors for developing deep vein thrombosis. The compression therapy devices may be used 24 hours a day for the entire hospitalization period. Clinical studies have shown that the effectiveness of such devices is primarily determined by patient and staff compliance, which in turn is affected by ease of use and patient comfort. The usage of such devices is also determined by economic factors such as cost of the device and garments as opposed to pharmaceutical interventions such as heparin.

U.S. Pat. No. 8,313,450 discloses a disposable sleeve for compression therapy, with at least one inflatable air cell defined between a first airtight wall adjacent a patient's body to be treated and a second airtight wall. Each of the first and second walls includes an external porous layer and an internal layer including air-tight polyethylene (PE). The walls are bonded by molten portions of the PE internal layer penetrating and set in their corresponding external porous layers and welded to each other, the bonding enduring at least 250 inflation-deflation cycles associated with the therapy.

There remains a need for cheap inflatable compression sleeves, which are easy to use, thereby increasing patient and medical staff compliance.

### SUMMARY

Aspects of the invention, in some embodiments thereof, relate to inflatable compression sleeves for use in pneumatic compression therapy.

FIG. 1 depicts an inflatable compression sleeve 100, according to prior-art. Compression sleeve 100 includes a sleeve central portion 102, a first flap 104, and a second flap 106. Sleeve central portion 102 is bordered on the sides thereof by flaps 104 and 106. Flaps 104 and 106 may be removably fastened onto one another, such as to allow securing compression sleeve 100 about a limb of a subject.

Compression sleeve 100 is made of adjacent (wrappable) thin layers, joined (e.g. welded) along seams 108 to define four adjacent pockets 110: a first pocket 110a, a second pocket 110b, a third pocket 110c, and a fourth pocket 110d, located one above the other. Pockets 110a-110d extend transversely across sleeve central portion 102. When deflated and spread out (e.g. along the yz plane as depicted in FIG. 1), compression sleeve 100 is shaped substantially as a sheet.

Compression sleeve 100 further includes a tubing braid 112. Tubing braid 112 includes a connector 114 and four flexible tubes (hoses): a first tube 116a, a second tube 116b, a third tube 116c, and a fourth tube 116d. Connector 114 is configured to connect to an inflating device (i.e. an air pump with an air distributor valve). Each of tubes 116a-116d is connected on a distal end thereof, respectively, to connector 114 and on a proximal end thereof, respectively, to a respective one of pockets 110a-110d.

Embodiments of the present invention provide an inflatable compression sleeve which does not include an external tubing braid and having air inlets which may be connected to an inflating device via a single connector. The exclusion of an external tubing braid and the connection to a single connector simplify the use of the compression sleeve and contribute to the comfort of a subject, thereby increasing subject and medical staff compliance.

Further, the exclusion of an external tubing braid not only cuts production costs but is also environment-friendly since the disclosed compression sleeves contain significantly less plastic than external tubing braid-including prior art compression sleeves, such as prior art compression sleeve 100, thereby also cutting down on plastic-waste.

Thus, according to an aspect of some embodiments, there is provided an inflatable compression sleeve for performing compression therapy on a limb of a subject. the compression sleeve includes a plurality of inflatable pockets, each extending substantially transversely. Each of the pockets is adjacent to at least one other pocket from the plurality of pockets. Each of the pockets respectively includes a first wall, a second wall opposite to the first wall, and an air inlet. Each of the first walls and the second walls is airtight. When the compression sleeve is wrapped about a limb of a subject, each of the second walls is adjacent to the limb. At least one of the pockets is fingered, including a pocket extension projecting substantially longitudinally (i.e. substantially upwards or substantially downwards) from a pocket main portion of the respective pocket. The pocket extension includes the respective air inlet.

According to some embodiments, at least two of the pockets are fingered.

According to some embodiments, all the pockets are fingered.

According to some embodiments, the pocket extensions and the air inlets are configured such as to allow connecting the air inlets to a single connector of an inflating device.

According to some embodiments, widths of the pocket extensions are such as to facilitate connecting the air inlets to a single connector.

According to some embodiments, the air inlets are aligned, thereby facilitating connection thereof to a single connector.

According to some embodiments, at least two of the pockets are fingered. Each of the pocket extensions is adjacent to at least one other of the pocket extensions.

According to some embodiments, all the pocket extensions project substantially downwards.

According to some embodiments, the air inlets are located near a lower edge of the inflatable compression sleeve.

According to some embodiments, the pocket extensions alternately project upwards and downwards.

According to some embodiments, the air inlets are located midway, or substantially midway, between an upper edge and a lower edge of the inflatable compression sleeve.

According to some embodiments, the air inlets are arranged asymmetrically, and/or at least one of the air inlets includes an asymmetrical feature, such as to allow connection to a matching asymmetrical connector only in a single orientation of the asymmetrical connector.

According to some embodiments, the first wall of each pocket is connected to the second wall of the pocket along a respective at least one airtight seam.

According to some embodiments, the respective first wall and second wall of each pocket are welded and/or glued along the respective at least one airtight seam.

According to some embodiments, the compression sleeve further includes a first flap and a second flap extending from two side edges respectively of a sleeve central portion. The sleeve central portion includes the pockets. The flaps are configured to fasten onto one another and thereby allow fastening the compression sleeve about a limb of a subject.

According to some embodiments, an outer surface of the first flap includes loop PE, loop EVA, loop PVC, or loop TPU, and an inner surface of the second flap includes hook PE, hook EVA, hook PVC, or hook TPU, respectively.

According to some embodiments, an outer surface of the sleeve central portion includes loop PE, loop EVA, loop PVC, or loop TPU, such as to allow fastening the second flap thereto.

According to some embodiments, the first wall includes a first wall internal layer and a first wall external layer, and the second wall includes a second wall internal layer and a second wall external layer. The first wall internal layer and the second wall internal layer are made of airtight materials.

According to some embodiments, regions in the compression sleeve, which do not include the pockets, include ventilation holes.

According to some embodiments, the first flap includes ventilation holes.

According to some embodiments, each pocket, which is fingered further includes a respective spacer in the form of a thin layer between the respective first wall and second wall. At least a part of each spacer is located in the respective pocket extension. Each spacer is configured to prevent adherence at the pocket extension of the respective first wall and the respective second wall to the spacer.

According to some embodiments, each of the spacers is non-smooth.

According to some embodiments, each of the spacers is a net.

According to some embodiments, each of the spacers is made of non-stick material.

According to some embodiments, the sleeve central portion includes five layers:
an outer sheet of porous material including the first wall external layers;
a first airtight sheet including the first wall internal layers;
an extended spacer, which includes the spacers, and which extends along at least a part of the sleeve central portion;
a second airtight sheet including the second wall internal layers; and
a non-woven garment including the second wall external layers.

The five layers are disposed on one another and are connected such as to define the pockets.

According to some embodiments, the outer sheet includes loop PE, loop EVA, loop PVC, or loop TPU.

According to some embodiments, the airtight sheets include PE, EVA, PVC, or TPU.

According to some embodiments, the five layers are connected by welding and/or by glue.

According to some embodiments, the first flap is also five layered.

According to some embodiments, the first wall and second wall are configured not to adhere to one another.

According to some embodiments, an internal layer of the first wall and an internal layer of the second wall, opposite to the internal layer of the first wall, are non-smooth.

According to some embodiments, the limb is a lower leg.

According to some embodiments, the limb is an upper arm.

According to some embodiments, when the inflatable compression sleeve is worn about a limb of a subject with at least one of the plurality of pockets being inflated, the second wall of the inflated pocket compresses a part of the limb adjacent thereto.

According to some embodiments, the plurality of inflatable pockets consists of three pockets.

According to some embodiments, each pocket extension has a respective width at a respective location of the respective air inlet measuring no more than three times a width of the air inlet.

According to some embodiments, each pocket extension projects from a respective transverse edge of the respective pocket main portion at an angle no greater than 30° relative to an axis normal to the transverse edge.

According to an aspect of some embodiments, there is provided an inflatable compression sleeve for performing compression therapy on a limb of a subject. The compression sleeve includes a plurality of inflatable pockets extending substantially transversely along the sleeve. Each of the pockets is adjacent to at least one other pocket from the plurality of pockets. Each of the pockets respectively includes an airtight first wall, an airtight second wall opposite to the first wall, and an air inlet. Each of the second wall is adjacent to the limb when the compression sleeve is wrapped about the limb. At least one of the pockets further includes a spacer configured to prevent adherence thereto of the respective first wall and the respective second wall. At least a part of the spacer being is between a first wall region of the respective first wall and a second wall region of the respective second wall. The first wall region including the respective air inlet.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 depicts an inflatable compression sleeve, according to the prior art;

FIG. 2a provides a front view of an inflatable compression sleeve, according to some exemplary embodiments of the present invention;

FIG. 2b provides a back view of the inflatable compression sleeve of FIG. 2a, according to some exemplary embodiments of the present invention;

FIG. 3a provides a cross-sectional view of a pocket extension of a fingered pocket of the inflatable compression sleeve of FIG. 2a, according to some exemplary embodiments of the present invention;

FIG. 3b provides a cross-sectional view of a pocket extension of a fingered pocket of the inflatable compression sleeve of FIG. 2a, according to some exemplary embodiments of the present invention;

FIG. 3c provides a cutaway front view of the inflatable compression sleeve of FIG. 2a, according to some exemplary embodiments of the present invention;

FIG. 4a provides a back view of a leg of a subject with the inflatable compression sleeve of FIG. 2a worn thereon on the lower leg, according to some exemplary embodiments of the present invention;

FIG. 4b provides a side view of the leg and the inflatable compression sleeve of FIG. 4a, according to some exemplary embodiments of the present invention;

FIG. 4c provides a perspective view of the leg and the inflatable compression sleeve of FIG. 4a, according to some exemplary embodiments of the present invention;

FIG. 5 provides a front view of an inflatable compression sleeve, according to some exemplary embodiments of the present invention;

FIG. 6 provides a front view of an inflatable compression sleeve, according to some exemplary embodiments of the present invention; and

FIG. 7 provides a front view of an inflatable compression sleeve, according to some exemplary embodiments of the present invention.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, each of the words “comprise” “include” and “have”, and forms thereof, are not necessarily limited to members in a list with which the words may be associated.

For ease of description, in some of the figures a three-dimensional cartesian coordinate system (with orthogonal axes x, y, and z) is introduced. It is noted that the orientation of the coordinate system relative to a depicted object may vary from one figure to another. Further, the symbol ⊙ is used in the figures to represent an axis pointing “out of the page”, while the symbol ⊗ is used in the figures to represent an axis pointing “into the page”.

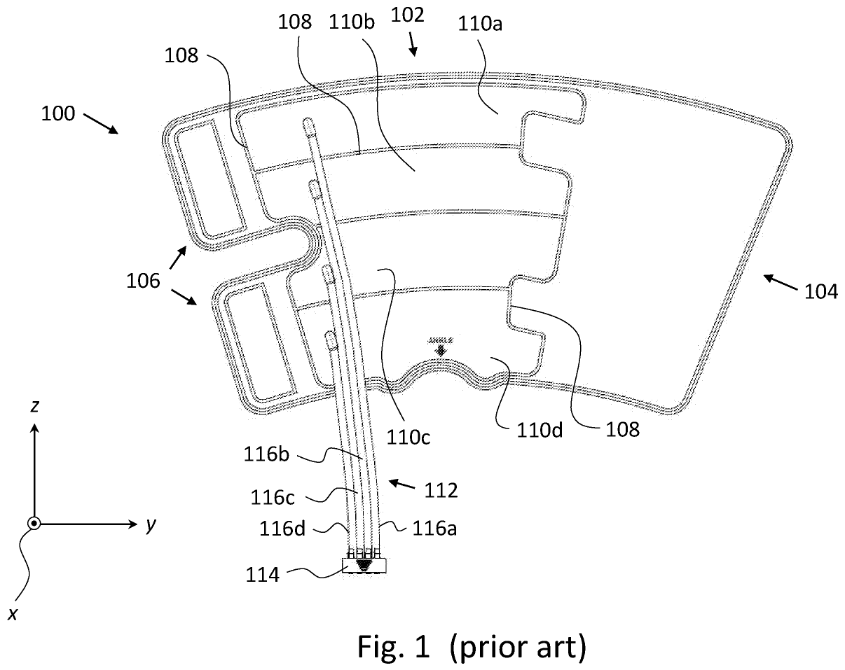

As used herein, “right” and “left” refer to the right and left directions from the point of view of a reader perusing the figures. Accordingly, in FIGS. 1, 2a, 3c, 4b, and 5-7, for example, the right direction will be understood to point along the positive y axis (i.e. along ŷ), while the left direction will be understood to point along the negative y axis (i.e. along −ŷ).

As used herein, the term “about” is used to specify a value of a quantity or parameter (e.g. the length of an element) to within a continuous range of values in the neighborhood of (and including) a given (stated) value. According to some embodiments, “about” specifies the value of a parameter to be between 80% and 120% of the given value. For example, the statement “the length of the element is equal to about 1 m” is equivalent to the statement “the length of the element is between 0.8 m and 1.2 m”. According to some embodiments, “about” specifies the value of a parameter to be between 90% and 110% of the given value. According to some embodiments, “about” specifies the value of a parameter to be between 95% and 105% of the given value.

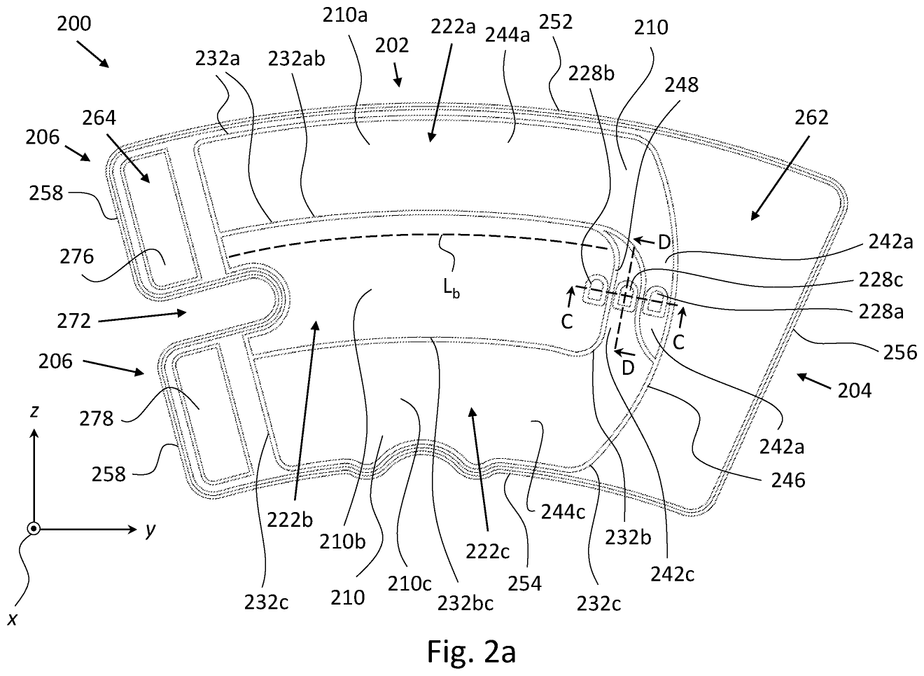

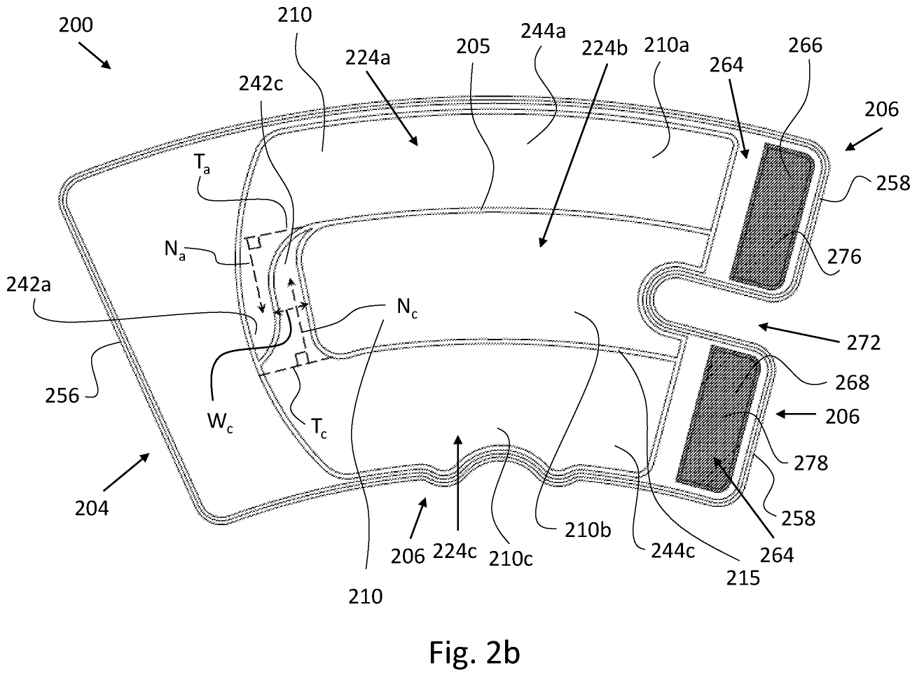

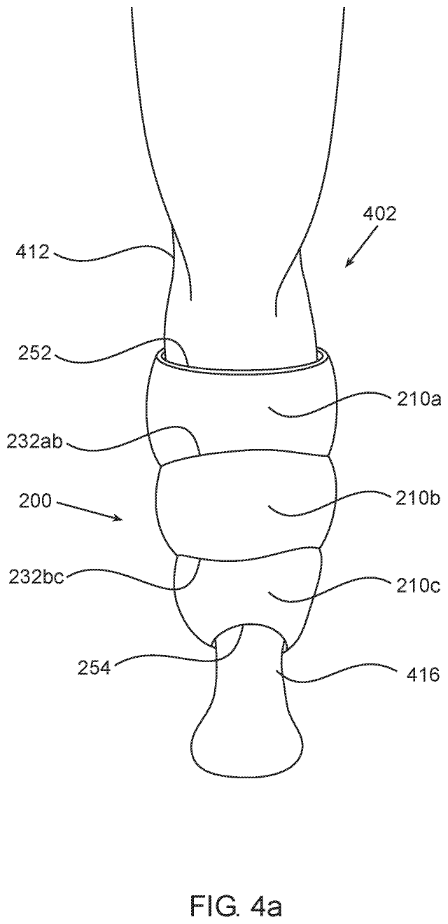

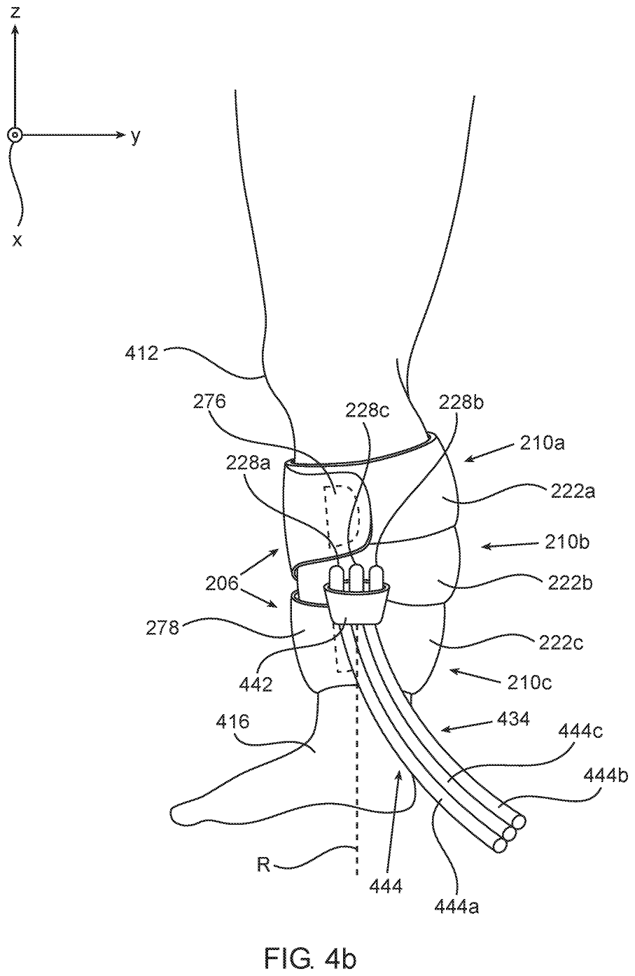

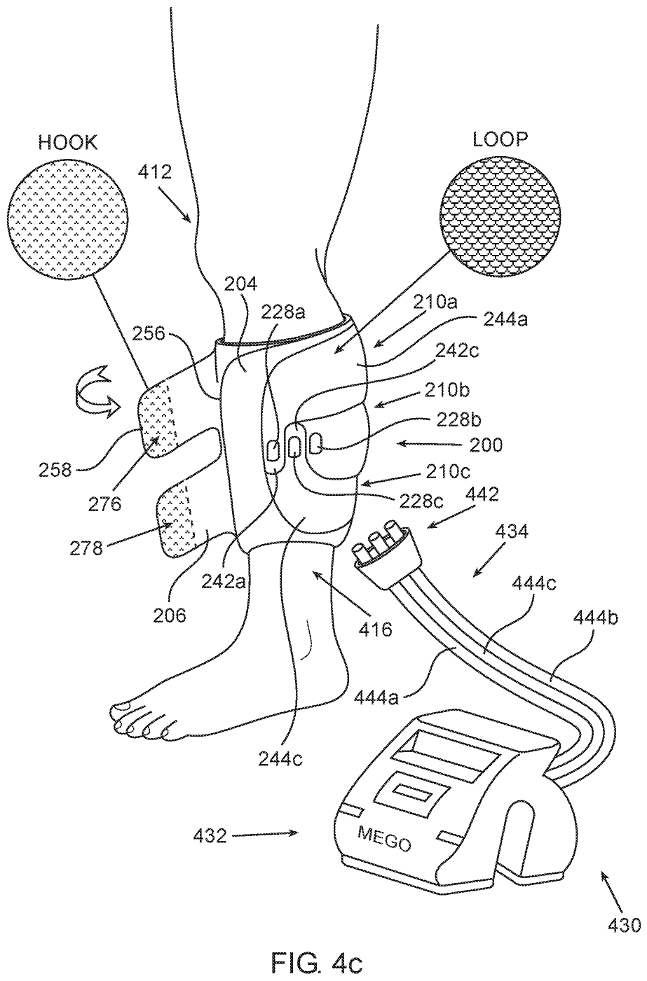

FIGS. 2a and 2b provide a front view and a back view, respectively, of an inflatable compression sleeve 200, when deflated, according to some embodiments of the present invention. Compression sleeve 200 is configured to be worn (wrapped) about a limb of a subject (e.g. a patient), as elaborated on below. According to some embodiments, and as depicted in FIGS. 4a-4c, compression sleeve 200 is configured to be worn about a lower leg of a subject. According to some embodiments, compression sleeve 200 is configured to be worn about an upper arm of a subject.

As elaborated on below, compression sleeve 200 is made of adjacent (wrappable, e.g. garment-like or film-like) thin layers. When deflated and spread out (e.g. along the yz plane as depicted in FIG. 2a), compression sleeve 200 is shaped substantially as a sheet.

Compression sleeve 200 includes a sleeve central portion 202, a first flap 204, and a second flap 206. Sleeve central portion 202 is bordered on the sides thereof by flaps 204 and 206. Flaps 204 and 206 may be removably fastened onto one another, such as to allow securing compression sleeve 200 about a limb of a subject, as elaborated on below.

Sleeve central portion 202 includes a plurality of pockets 210. Pockets 210 include a first pocket 210a, a second pocket 210b, and a third pocket 210c. Each of pockets 210 is adjacent to at least one other pocket from plurality of pockets 210. Pockets 210a and 210b are adjacent, with second pocket 210b also being adjacent to third pocket 210c. Pockets 210 are arranged one above the other (the “upwards” direction being defined by the z axis). First pocket 210a is the topmost of pockets 210, being located directly above second pocket 210b.

Each of pockets 210 extends along, or substantially along, a respective length of sleeve central portion 202. That is to say, each of pockets 210 extends transversely (from one side edge of sleeve central portion 202 to the other side edge thereof) or substantially transversely. For example, second pocket 210b extends along the length thereof, indicated by a curved (dashed) line L_{b}. In particular, when compression sleeve 200 is wrapped about a limb of a subject, each of pockets 210 extends about a respective circumference of the limb.

According to some embodiments, each of pockets 210 extends diagonally in parallel to the yz plane at an angle no greater than 30° relative to the y axis or an axis parallel thereto.

Each of pockets 210 includes a first wall, a second wall, and an air inlet (e.g. nozzle), respectively: First pocket 210a includes a first wall 222a, a second wall 224a (shown in FIG. 2b), and an air inlet 228a mounted in first wall 222a; second pocket 210b includes a first wall 222b, a second wall 224b (shown in FIG. 2b), and an air inlet 228b mounted in first wall 222b; and third pocket 210c includes a first wall 222c, a second wall 224c (shown in FIG. 2b), and an air inlet 228c mounted in first wall 222c. When compression sleeve 200 is worn on a limb of a subject, second walls 224a-224c are adjacent to the limb.

Air inlets 228a-228c are configured to allow for the pumping of air into, and the outflow of air (e.g. by passive deflation) from, pockets 210a-210c, respectively, thereby inflating and deflating the pockets. According to some embodiments, each of air inlets 228a-228c is female, being in the form of a socketed member. According to some embodiments, not depicted in the figures, air inlets 228a-228c are male, e.g. in the form of tubular spouts. Apart from the fluid connectivity provided by air inlets 228a-228c (fluidly connecting the inside of each of the pockets to the outside), pockets 210a-210c are airtight (i.e. fluidly sealed).

According to some embodiments, first walls 222a, 222b, and 222c are connected onto second walls 224a, 224b, and 224c along a respective seam(s), such as seams 232a, 232b, and 232c, respectively (i.e. first wall 222a is joined onto second wall 224a along seams 232a, and so on). According to some embodiments, the seams define the pockets, e.g. seams 232a define first pocket 210a. According to some such embodiments, a seam or a section of a seam may be associated with more than one pocket, in other words, two pockets may, at least partially, share one or more defining seams. For example, seam 232ab indicates a seam common to both seams 232a and 232b. Similarly, seam 232bc indicates a seam common both to seams 232b and 232c.

Seams 232a-232c are airtight. According to some embodiments, first walls 222a, 222b, and 222c are welded and/or glued onto second walls 224a, 224b, and 224c along seams 232a, 232b, and 232c, respectively.

Each of pockets 210a and 210c is fingered, including a pocket extension extending substantially longitudinally (i.e. substantially parallel to the z axis): First pocket 210a includes a pocket extension 242a extending (projecting) at an angle, e.g. at right angles, substantially downwards (along sleeve central portion 202) from a pocket main portion 244a of first pocket 210a. Third pocket 210c includes a pocket extension 242c extending (projecting) at an angle, e.g. at right angles, substantially upwards (along sleeve central portion 202) from a pocket main portion 244c of third pocket 210c. Pocket extensions 242a and 242c are narrow and elongated. Pocket extension 242a extends between a first flap inner edge 246 of first flap 204 (whereas first flap 204 borders sleeve central portion 202) and pocket extension 242c. Pocket extension 242c extends between a pocket side edge 248 of second pocket 210b and pocket extension 242a. In particular, when compression sleeve 200 is worn on a limb of a subject, pocket extensions 242a and 224c extend substantially along the length of the limb (e.g. substantially parallel to the axis R in FIG. 4b).

As used herein, according to some embodiments, “substantially upwards” refers to directions within 30° from the direction defined by the positive z axis (i.e. \hat{z}). Similarly, according to some embodiments, “substantially downwards” refers to directions within 30° from the direction defined by negative z axis (i.e. −\hat{z}).

As used herein, according to some embodiments, “substantially transversely” refers to directions within 30° from the y axis or an axis parallel thereto.

According to some embodiments, pocket extension 242a extends from a (lower) transverse edge 205 of pocket 210a at an angle no greater than 30° relative to a normal (indicated by an axis Nₐ shown in FIG. 2b) to transverse edge 205. Line Tₐ indicates the tangent to transverse edge 205 at the location wherefrom pocket extension 242a extends. Axis Nₐ is parallel to the yz plane. Similarly, according to some embodiments, pocket extension 242c extends from a (upper) transverse edge 215 of pocket 210c at an angle no greater than 30° relative to a normal (indicated by an axis N_{c} shown in FIG. 2b) to transverse edge 215. Line T_{c} indicates the tangent to transverse edge 205 at the location wherefrom pocket extension 242a extends. Axis Nₐ is parallel to the yz plane.

According to some embodiments, pocket extension 242a has a curved outline (parallel to the yz plane). According to some embodiments, pocket extension 242a has at least one curved side edge. The term “substantially downwards” with reference to the projection of the pocket is understood to cover also these options. According to some embodiments, pocket extension 242c has a curved outline (parallel to the yz plane). According to some embodiments, pocket extension 242c has at least one curved side edge. The term “substantially upwards” with reference to the projection of the of pocket is understood to cover also these options.

According to some embodiments, one or more of pockets 210 has a curved outline (parallel to the yz plane). According to some embodiments, one or more of pockets 210 has at least one transverse edge which is curved. The term “substantially transverse” with reference to the extension of the pockets is understood to cover also these options.

A first side edge 256 and a second side edge 258 of compression sleeve 200 are defined by the right and left edges, respectively, of compression sleeve 200 in FIG. 2a.

Air inlets 228a and 228c are located in pocket extensions 242a and 242c, respectively.

According to some embodiments, and as depicted in FIG. 2a, air inlets 228a-228c are aligned along a length of sleeve central portion 202: Air inlet 228c is located between air inlet 228a and air inlet 228b. According to some such embodiments, and as further elaborated on in the description of FIGS. 4b and 4c, air inlets 228a-228c are configured to allow connection thereof to a single connector (e.g. a casing including a plurality of linearly arranged air outlets, e.g. tubular spouts, each fluidly associated with a respective tube, such as the connector shown in FIGS. 4b and 4c) of an inflating device (such as the inflating device shown in FIG. 4c), thereby fluidly coupling pockets 210 to the inflating device. That is to say, the location and orientation of each of air inlets 228a-228c is such as to allow connection thereof to a single connector. In particular, the distances between adjacent air inlets (e.g. the distance between air inlets 228a and 228c) are sufficiently small to allow direct connection of air inlets 228a-228c to a single connector. According to some embodiments, the distances between adjacent air inlets (sidewall to adjacent sidewall) are between about 0.5 cm and about 3 cm or even between about 1 cm and about 2 cm.

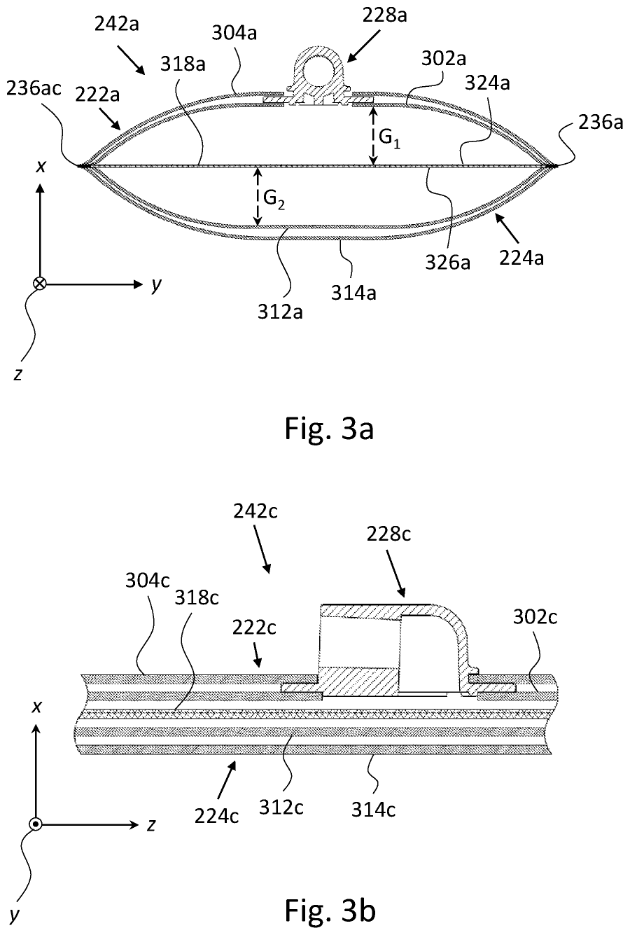

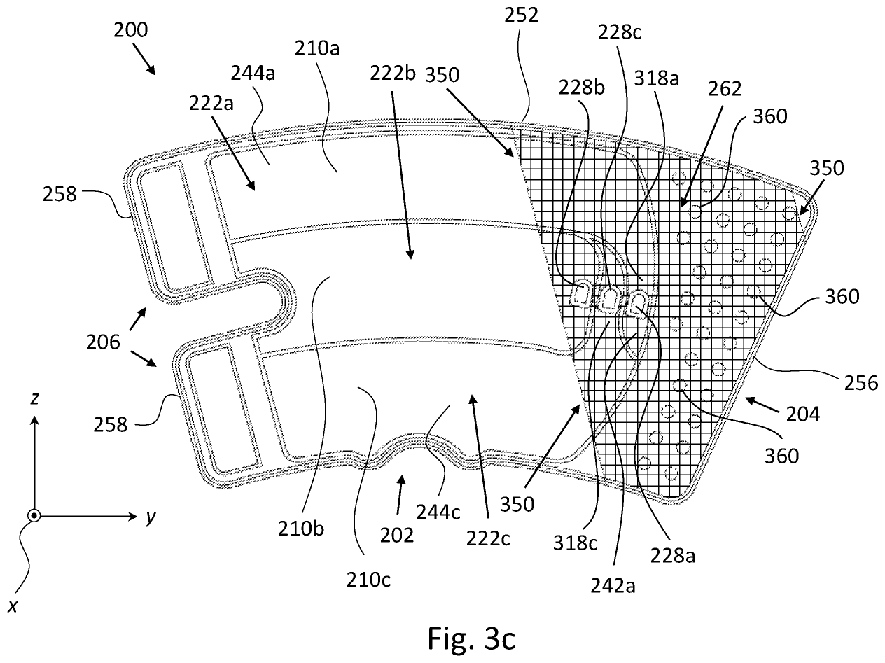

Advantageously, the option of connecting the air inlets directly to a single connector does away with the need: (i) to individually (directly) connect, one at a time, each of the air inlets to a respective tube (hose), or (ii) to include (external) tubes as part of the compression sleeve as in the prior-art compression sleeve 100 depicted in FIG. 1. It is noted that the exclusion of external tubes is made possible in compression sleeve 200 by the presence of pocket extensions 242a and 242c (and spacers therein as described in the description of FIGS. 3a-3c), which according to some embodiments effectively act as internal tubes for leading air from/to air inlets 228a and 228c to/from pocket main portions 244a and 244c, respectively.

In embodiments wherein air inlets 228a-228c are configured to connect to a single connector, the distances between the air inlets may limit the width of the pocket extensions, at least in the respective regions of the pocket extensions wherein the air inlets are mounted. For example, in FIG. 2a the width of pocket extension 242c (indicated by double-arrowed line W_{c} in FIG. 2b), in the region wherein air inlet 228c is mounted, must be sufficiently small, e.g. about 2 cm, such that each of air inlets 228a and 228b is sufficiently proximal (close) to air inlet 228c to allow connection to a single connector, as elaborated on below.

According to some embodiments, air inlets 228a-228c are configured asymmetrically, such that if a matching (asymmetrical) connector is disconnected from the air inlets and flipped (rotated by 180°, e.g. around axis R in FIG. 4b), the connector cannot be reconnected (unless flipped back first). That is to say, the connector can be connected only in a single orientation. An example of an asymmetrical configuration is one wherein distances between adjacent air inlets vary from one pair of adjacent air inlets to another (e.g. an embodiment wherein the distance between air inlets 228a and 228c is different than the distance between air inlets 228b and 228c). Another class of examples is provided by configurations wherein the air inlets differ from one another in shape and/or size, e.g. include an asymmetrical feature. An example of such a configuration is provided by an embodiment wherein the air inlets are female, i.e. include sockets (with the single connector including matching male members), and wherein the socket of one of the side air inlets, e.g. the socket of air inlet 228a, is smaller (e.g. narrower) than the sockets of the other air inlets.

An outer surface 262 of first flap 204 and an inner surface 264 (shown in FIGS. 2b and 4c) of second flap 206 are configured to detachably adhere onto one another, thereby allowing to secure compression sleeve 200 about a limb of subject (as illustrated in FIGS. 4a-4c). According to some embodiments, outer surface 262 and inner surface 264 include a loop Velcro layer and a hook Velcro layer, respectively, or vice-versa.

Each of the fingered pockets (i.e. pockets 210a and 210c) includes a respective spacer, at least a part of the spacer being located in the pocket extension. The spacers are intended to prevent air blockages in the pocket extensions, as elaborated on below.

FIG. 3a depicts a transverse cross-section of pocket extension 242a taken along a line C-C (shown in FIG. 2a) when pocket extension 242a is at least partially inflated. (Line C-C also intersects air inlet 228a, so that a cross-section of air inlet 228a is also depicted.) First wall 222a includes a first wall internal layer 302a and a first wall external layer 304a. Second wall 224a includes a second wall internal layer 312a and a second wall external layer 314a. A spacer 318a, in the shape of a thin layer extending in parallel to the yz plane (the z axis pointing “into the page”), is located between first wall internal layer 302a and second wall internal layer 312a. Spacer 318a includes a first spacer surface 324a and second spacer surface 326a.

A gap between first spacer surface 324a and first wall internal layer 302a is indicated by line G₁. A gap between second wall internal layer 312a and second spacer surface 326a is indicated by line G₂. First wall internal layer 302a and second wall internal layer 312a form the inner surfaces of first pocket 210a. (Only a part of first wall internal layer 302a and only a part of first wall external layer 304a are shown in FIG. 3a.) First wall external layer 304a and second wall external layer 314a form the outer surfaces of first pocket 210a. (Only a part of second wall internal layer 312a and only a part of second wall external layer 314a are shown in FIG. 3a.) Internal layers 302a and 312a are airtight. According to some embodiments, internal layers 302a and 312a are made of a material including polyethylene (PE), or ethylene-vinyl acetate (EVA), or polyvinyl chloride (PVC), or thermoplastic polyurethane (TPU), or the like (e.g. a similar polymer). According to some embodiments, first wall external layer 304a includes loop PE, or loop EVA, or loop PVC, or loop TPU, or the like, and second wall external layer 314a is a non-woven garment. According to some embodiments, first wall external layer 304a is porous. According to some embodiments, second wall external layer 314a is textile, preferably non-woven, and made of polyester or polypropylene.

Spacer 318a is configured to prevent adherence thereto of first wall internal layer 302a and second wall internal layer 312a and thereby to help prevent air blockages in pocket extension 242a. According to some embodiments, and as depicted in FIG. 3c, spacer 318a is a net. According to some embodiments, the net is made of EVA, or PVC, or TPU, or the like (e.g. a similar polymer). According to some embodiments, spacer 318a is a plurality of parallel straps. According to some embodiments, first spacer surface 324a and second spacer surface 326a are non-smooth. According to some embodiments, spacer surfaces 324a and 326a are made of non-stick material. According to some embodiments, wherein wall internal layers 302a and 312a are made of PE/EVA/PVC/TPU, spacer 318a is made of a material to which PE/EVA/PVC/TPU, respectively, does not adhere.

FIG. 3b depicts a longitudinal cross-section of pocket extension 242c (and air inlet 228c) taken along a line D-D (shown in FIG. 2a) when pocket 210c is deflated. Pocket extension 242c includes a spacer 318c similar to spacer 318a. Also depicted are layers 302c and 304c of first wall 222c (similar to layers 302a and 304a, respectively), and layers 312c and 314c of second wall 224c (similar to layers 312a and 314a, respectively).

According to some embodiments, when compression sleeve 200 is worn about a limb of a subject, each of pockets 210 extends along at least 50% of a girth of the limb, or along at least 67% of a circumference thereof, or even along at least 75% of a circumference thereof, as elaborated on below and in the description of FIGS. 4a-4c.

Making reference to FIG. 3c, according to some embodiments, compression sleeve 200 includes an extended spacer 350. Extended spacer 350 is a single layer extending at least throughout all the pocket extensions, i.e. pocket extensions 242a and 242c. In particular, extended spacer 350 includes spacers 318a and 318c.

According to some such embodiments, sleeve central portion 202 includes five layers: an outer sheet of porous material (e.g. loop EVA), a first airtight sheet (e.g. made of EVA), extended spacer 350 (e.g. an EVA net) which may extend only partially (rather than fully) throughout central sleeve portion 202, a second airtight sheet (e.g. made of EVA), and a non-woven garment. According to some embodiments, the outer sheet and the first airtight sheet may be bonded onto one another throughout adjacent surfaces thereof. Similarly, according to some embodiments, the second airtight sheet and the non-woven garment may be bonded onto one another throughout adjacent surfaces thereof. The outer sheet, first airtight sheet, the second airtight sheet and the non-woven garment are connected (e.g. by welding) onto one another along seams 232a-232c, thereby defining pockets 210a-210c, with extended spacer 350 also being welded thereto in parts of sleeve central portion 202 wherein extended spacer 350 is present.

More specifically, the outer sheet defines first wall external layer 304a, the first airtight sheet defines first wall internal layer 302a, extended spacer 350 defines spacer 318a, the second airtight sheet defines second wall internal layer 312a, and the non-woven garment defines second wall external layer 314a. Constituents (elements) of pockets 210b and 210c are similarly defined. According to some embodiments, extended spacer 350 extends all throughout sleeve central portion 202. That is to say, from an upper edge 252 of sleeve central portion 202 to a lower edge 254 of sleeve central portion 202 and from first flap 204 to second flap 206. In such embodiments, extended spacer 350 is porous, allowing passage of air therethrough, e.g. in pocket extension 242a from the volume defined by gap G₁ to the volume defined by gap G₂.

According to some embodiments, extended spacer 350 extends into first flap 204. According to some embodiments, first flap 204 is five-layered, similarly to sleeve central portion 202. The outer layer in first flap 204 defines outer surface 262 of first flap 204. According to some such embodiments, second flap 206, or a part thereof, is five-layered, being defined by the layers of sleeve central portion 202 except for spacer 350 and including an additional sheet (e.g. of hook EVA) or a Velcro pad attached to the non-woven garment and configured to removably attach onto the outer layer. The additional sheet defines inner surface 264 of second flap 206, or surfaces proximal (close) to and bordering, second side edge 258 of compression sleeve 200, such as a first near-edge surface 266 and a second near-edge surface 268 (shown in FIG. 2b). According to some embodiments, extended spacer 350 extends into second flap 206.

It is noted that according to some of the embodiments disclosed above, all of the outer surface of compression sleeve 200 include loop EVA or the like. An advantage offered by such embodiments is the possibility of fastening second flap 206 onto any region on the outer surface of compression sleeve 200 (e.g. onto first walls 222a-222c on sleeve central portion 202), rather than only to first flap 204. In particular, this allows using such an embodiment of compression sleeve 200 over a greater range of limb girths as compared, for example, to prior art compression sleeves wherein the second flap can only be fastened onto the first flap (e.g. onto loop Velcro patches thereon).

According to some embodiments, first flap 204 includes ventilation holes, such as ventilation holes 360 in FIG. 3c. When compression sleeve 200 is worn about a limb, such as the lower leg depicted in FIGS. 4a-4c, the ventilation holes act to significantly increase air recirculation near skin of the limb, thereby not only decreasing potential subject discomfort but helping to prevent excess perspiration and consequent rashes and skin infections. According to some embodiments, second flap 206 includes/also includes ventilation holes, such as ventilation holes 360. According to some embodiments, regions in the sleeve which do not include pockets 210a-210c include ventilation holes, such as ventilation holes 360.

FIGS. 4a-4c show compression sleeve 200 worn about a lower leg 402 of a subject. First pocket 210a is wrapped about lower leg 402 just below a knee 412 of the subject. Second pocket 210b is wrapped about lower leg 402 at the mid-portion of lower leg 402. Third pocket 210c is wrapped around lower leg 402 just above an ankle 416 of lower leg 402.

FIGS. 4a-4c provide a back view, a side view, and a perspective view, respectively, of lower leg 402 with compression sleeve 200 worn thereon. An axis R, drawn in FIG. 4b in order to facilitate the description below, runs parallel to the z axis.

FIG. 4c further depicts an inflating device 430 including a device body 432 and a tubing braid 434. Tubing braid 434 includes a connector 442 and a plurality of tubes 444: a first tube 444a, a second tube 444b, and a third tube 444c. Inflating device 430 further includes an air distributor valve (not shown) configured to allow selectively pumping air into, or passively deflating (or sucking air out of), each of tubes 444a-444c (e.g. to allow pumping air into tubes 444a-444c one at a time). Connector 442 is configured to connect to air inlets 228a-228c, thereby fluidly coupling pockets 210a-210c to device body 432 via tubes 444a-444c, respectively.

According to some embodiments, each of pocket extensions 242a and 242c has a width (a width of pocket extension 242a is indicated by line Wb in FIG. 2b) larger by a factor of about 1.5 than the diameters of the tubes 444a-444c. According to some embodiments, each of pocket extensions 242a and 242c has a width larger by a factor of about 2 than the diameters of tubes 444a-444c. According to some embodiments, each of pocket extensions 242a and 242c has a width larger by a factor of about 3 than the diameters of tubes 444a-444c. According to some embodiments, the widths of pocket extensions 242a and 242c are between about 0.5 cm and about 4 cm or even between about 1.5 cm and about 3 cm. According to some embodiments, the width of pocket extensions 242a and 242c are between about 5% and about 15% of the respective lengths thereof.

According to some embodiments, pockets 210 differ from one another in length (e.g. the length of pocket 210b is given by the length of curved line L_{b} in FIG. 2a), such as to conform to the variation in the girth of a limb along the limb (e.g. variations in girth from the knee to the ankle). According to some such embodiments, wherein compression sleeve 200 is intended to be worn about a lower leg of a subject, the width of third pocket 210c may be smaller than the respective widths of pockets 210a and 210b; the region of the lower leg just above the ankle being typically of a smaller girth than the rest of the lower leg.

Making reference also to FIGS. 2a-2b, according to some embodiments, second flap 206 is recessed. A recess 272 partitions second flap 206 into two portions: A second flap upper portion 276 and a second flap lower portion 278. Recess 272 location and dimensions are such as facilitate securely fastening second flap upper portion 276 and second flap lower portion 278 onto sleeve central portion 202 above and below air inlets 228a-228c, respectively (in embodiments wherein the outer surface of sleeve central portion 202 includes loop EVA or the like). The option of fastening second flap 206 onto sleeve central portion 202 allows for the use of compression sleeve 200 on subjects differing from one another in the girths of respective limbs. For example, on a subject with a lower leg of a large girth, second flap 206 is fastened onto first flap 204 when compression sleeve 200 is worn on the lower leg, while on a subject with a lower leg of a small girth, second flap 206 is fastened onto sleeve central portion 202 when compression sleeve 200 is worn on the lower leg.

According to some embodiments, not depicted in the figures, wherein the outer surface of sleeve central portion 202 includes loop EVA or the like, compression sleeve 200 includes only a single flap, such as second flap 206, instead of a pair of flaps on the two sides of sleeve central portion 202, respectively. The flap includes a hook EVA surface, or the like, and is configured to be removably fastened onto sleeve central portion 202.

According to some embodiments, not depicted in the figures, there is provided an inflatable compression sleeve similar to compression sleeve 200 but differing therefrom in including four or more pockets. At least three of the pockets are fingered. The pocket extensions of the fingered pockets are adjacent, similarly to pocket extensions 242a and 242c.

According to some embodiments, not depicted in the figures, there is provided an inflatable compression sleeve similar to compression sleeve 200 but differing therefrom in including only two pockets. One of the two pockets is fingered, being similar to first pocket 210a (or third pocket 210c) of compression sleeve 200, while the other pocket is not fingered, being similar to second pocket 210b of compression sleeve 200.

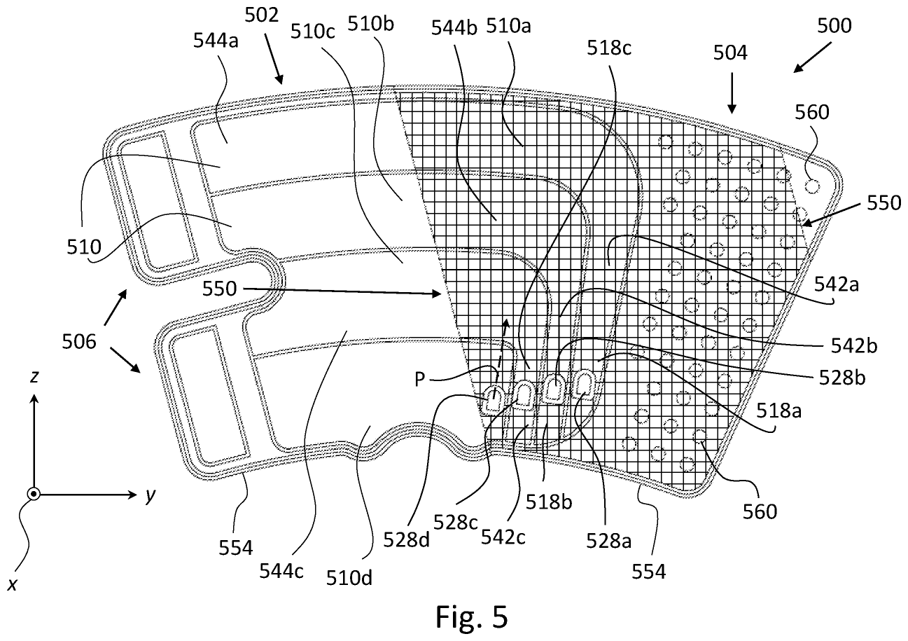

FIG. 5 depicts a front view of an inflatable compression sleeve 500, according to some embodiments. Compression sleeve 500 includes a plurality of pockets 510. Compression sleeve 500 is similar to compression sleeve 200 but differs therefrom in that the pocket extensions of each of pockets 510, which are fingered, extend substantially downwards from the respective pocket main portions of the fingered pockets, whereas in compression sleeve 200, pocket extension 242c extends substantially upwards from pocket main portion 244c.

According to some embodiments, and as depicted in FIG. 5, compression sleeve 500 further differs from compression sleeve 200 in that the air inlets in compression sleeve 500 are located near the bottom of compression sleeve 500 (i.e. near a lower edge 554), whereas in compression sleeve 200 air inlets 228a-228c are located about midway between the top and bottom of compression sleeve 200, i.e. upper edge 252 and lower edge 254, respectively.

More specifically, according to some embodiments, compression sleeve 500 includes a sleeve central portion 502, a first flap 504, and a second flap 506. Sleeve central portion 502 includes pockets 510 and is bordered on the sides thereof by flaps 504 and 506. Flaps 504 and 506 may be removably fastened onto one another, such as to allow securing compression sleeve 500 about a limb of a subject.

According to some embodiments, pockets 510 include four pockets: a first pocket 510a, a second pocket 510b, a third pocket 510c, and a fourth pocket 510d. Each of pockets 510 is adjacent to a least one other of pockets 510. Pockets 510a and 510d are the topmost and bottommost of pockets 510, respectively. Second pocket 510b is adjacent to pockets 510a and 510c, being located there between. Third pocket 510c is adjacent to pockets 510b and 510d, being located there between.

Pockets 510a, 510b, and 510c are fingered: First pocket 510a includes a pocket extension 542a extending substantially downwards from a pocket main portion 544a of first pocket 510a. Second pocket 510b includes a pocket extension 542b extending substantially downwards from a pocket main portion 544b of second pocket 510b. Third pocket 510c includes a pocket extension 542c extending substantially downwards from a pocket main portion 544c of third pocket 510c. Pocket extensions 542a-542c are elongated with pocket extension 542b being adjacent to each of pocket extensions 542a and 542c and extending there between. Pocket extension 542a extends between first flap 504 and pocket extension 542b. Pocket extension 542c extends between pocket extension 542b and the right side edge of fourth pocket 510d.

Air inlets 528a-528c are located in pocket extensions 542a-542c, respectively, near the bottoms thereof. An air inlet 528d is located in fourth pocket 510d adjacent to air inlet 528c. Each of the fingered pockets includes a spacer, similar to spacer 318a, essentially as described with respect to the fingered pockets of compression sleeve 200. Pocket extension 510a includes a spacer 518a, pocket extension 510b includes a spacer 518b, and pocket extension 510c includes a spacer 518c. In particular, each spacer extends along the respective pocket extension, at least along the region of the pocket extension wherein the respective air inlet is located. Similarly to air inlets 228a-228c of compression sleeve 200, air inlets 528a-528d are also configured to be connected to a single connector.

According to some embodiments, each of air inlets 528a-528d is a female member including a respective socket. Air inlets 528a-528d are arranged asymmetrically as follows: Air inlet 528a is located slightly above (e.g. 0.5 cm as measured along an axis P parallel to the yz plane) air inlet 528b, which is located slightly above air inlet 528c, which is located slightly above air inlet 528d, while the sockets of all of air inlets 528a-528d point along the same direction opposite to axis P. A single connector configured to be connected to air inlets 528a-528d will have a matching asymmetrical configuration.

According to some embodiments, regions in compression sleeve 500 which do not include pockets 510a-510d (e.g. first flap 504) include ventilation holes 560, similar to ventilation holes 360.

According to some embodiments, sleeve central portion 502 is five-layered (i.e. includes five thin layers), essentially as described with respect to sleeve central portion 202 of compression sleeve 200. In such embodiments, compression sleeve 500 includes an extended spacer 550, similar to extended spacer 350 of compression sleeve 200. Extended spacer 550 includes spacers 518a-518c. According to some such embodiments, first flap 504 and optionally second flap 506 are also five-layered, essentially as described with respect to first flap 204 and second flap 206 of compression sleeve 200.

According to some embodiments, compression sleeve 500 is configured to be worn about a lower leg of a subject. According to some embodiments, compression sleeve 500 is configured to be worn about an upper arm of a subject.

According to some embodiments, all, or substantially all, of the outer surface of sleeve central portion 502 is made of loop EVA or the like. According to some embodiments, all, or substantially all, of the outer surface of compression sleeve 500 is made of loop EVA or the like.

According to some embodiments, not depicted in the figures, there is provided a compression sleeve similar to compression sleeve 500 but differing therefrom in including only two/three pockets, one/two of which, respectively, being fingered.

According to some embodiments, not depicted in the figures, there is provided a compression sleeve similar to compression sleeve 500, but differing therefrom in including at least five pockets, all but one of which are fingered.

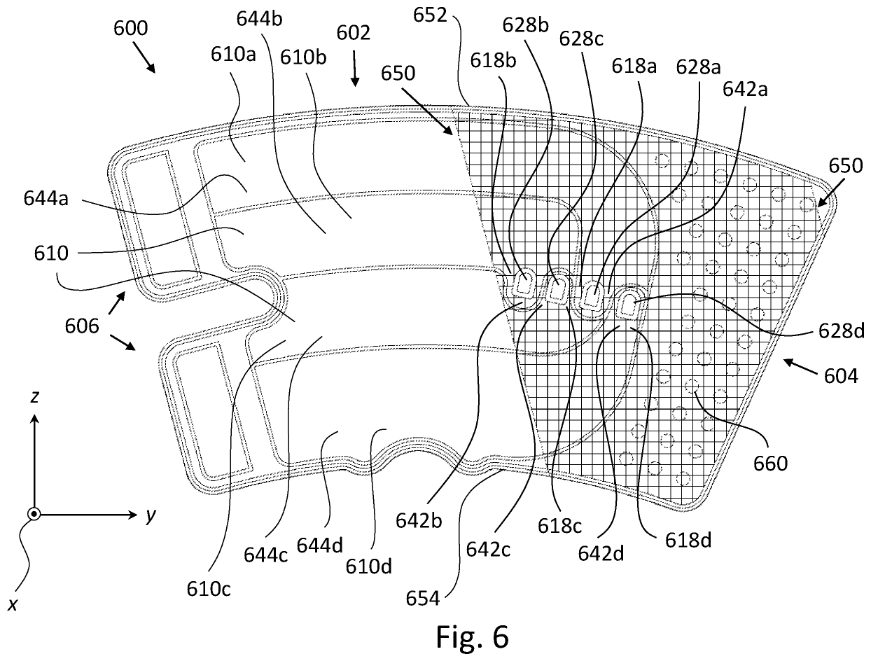

FIG. 6 depicts a front view of an inflatable compression sleeve 600, according to some embodiments. Compression sleeve 600 includes a plurality of pockets 610. Compression sleeve 600 is similar to compression sleeve 200 but differs therefrom in that all of pockets 610 are fingered (i.e. include a respective pocket extension), whereas in compression sleeve 200, second pocket 210b is not fingered.

More specifically, the pocket extensions are arranged in an alternating pattern wherein each pair of adjacent pocket extensions includes one substantially upwards extending pocket extension and one substantially downwards extending pocket extension.

According to some embodiments, compression sleeve 600 includes a sleeve central portion 602, a first flap 604, and a second flap 606. Sleeve central portion 602 includes pockets 610 and is bordered on the sides thereof by flaps 604 and 606. Flaps 604 and 606 may be removably fastened onto one another, such as to allow securing compression sleeve 600 about a limb of a subject.

According to some embodiments of compression sleeve 600, and as depicted in FIG. 6, plurality of pockets 610 includes four pockets: a first pocket 610a, a second pocket 610b, a third pocket 610c, and a fourth pocket 610d. Pockets 610a-610d include pocket main portions 644a-644d, respectively. Pockets 610a-610d further include pocket extensions 642a-642d, respectively.

Pocket main portion 644a is adjacent to, and located above, pocket main portion 644b. Pocket main portion 644b is adjacent to, and located above, pocket main portion 644c. Pocket main portion 644c is adjacent to, and located above, pocket main portion 644d. Pocket extensions 642a and 642b extend substantially downwards from pocket main portions 644a and 644b, respectively. Pocket extensions 642c and 642d extend substantially upwards from pocket main portions 644c and 644d, respectively. Pocket extension 642c is bordered on the sides thereof by pocket extensions 642b and 642a (and on the top thereof by pocket main portion 644b). Pocket extension 642a is bordered on the sides thereof by pocket extensions 642c and 642d (and on the bottom thereof by pocket main portion 644c). Pocket extension 642d is bordered on the left side thereof by pocket extension 642a and pocket main portion 644c, and on the right side thereof by first flap 604 (and on the top thereof by pocket main portion 644a). Pocket extension 642b is bordered by third pocket 610c: on the right pocket extension 642b is bordered by pocket extension 642c, while on the left (and on the bottom) pocket extension 642b is bordered by pocket main portion 644c.

Air inlets 628a-628d are located in pocket extensions 642a-642d, respectively. Each of the pockets includes a spacer, similar to spacers 318a and 318c, essentially as described with respect to the fingered pockets of compression sleeve 200. Pocket extension 610a includes a spacer 618a, pocket extension 610b includes a spacer 618b, pocket extension 610c includes a spacer 618c, and pocket extension 610d includes a spacer 618d. In particular, each spacer extends along the respective pocket extension, at least along the region of the pocket extension wherein the respective air inlet is located. Similarly to air inlets 228a-228c of compression sleeve 200, air inlets 628a-628d are also configured to be connected to a single connector.

According to some embodiments, pockets extensions 642a-642d are shorter than pockets extensions 242a and 242c of compression sleeve 200 and pocket extensions 542a-542c of compression sleeve 500. In particular, according to some such embodiments, pocket extensions 642a-642d are located about midway between an upper edge 652 and a lower edge 654 of compression sleeve 600 (so that air inlets 628a-628d are also located about midway between edges 652 and 654).

According to some embodiments, regions in compression sleeve 600 which do not include pockets 610a-610d (e.g. first flap 604) include ventilation holes 660, similar to ventilation holes 360.

According to some embodiments, sleeve central portion 602 is five-layered (i.e. includes five thin layers), essentially as described with respect to sleeve central portion 202 of compression sleeve 200. In such embodiments, compression sleeve 600 includes an extended spacer 650, similar to extended spacer 350 of compression sleeve 200. Extended spacer 650 includes spacers 618a-618d. According to some such embodiments, first flap 604 and optionally second flap 606 are also five-layered, essentially as described with respect to first flap 204 and second flap 206 of compression sleeve 200.

According to some embodiments, all, or substantially all, of the outer surface of sleeve central portion 602 is made of loop EVA or the like. According to some embodiments, all, or substantially all, of the outer surface of compression sleeve 600 is made of loop EVA or the like.

According to some embodiments, compression sleeve 600 is configured to be worn about a lower leg of a subject. According to some embodiments, compression sleeve 600 is configured to be worn about an upper arm of a subject.

According to some embodiments, not depicted in the figures, there is provided a compression sleeve similar to compression sleeve 600 but differing therefrom in including only two or three pockets (all of which are fingered).

According to some embodiments, not depicted in the figures, there is provided a compression sleeve similar to compression sleeve 600 but differing therefrom in including at least five pockets (all of which are fingered).

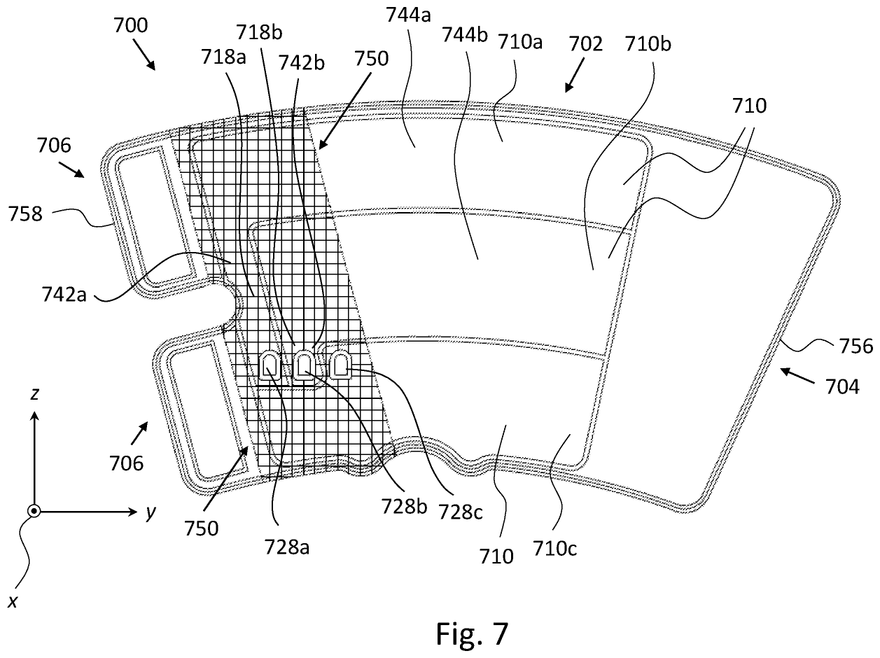

FIG. 7 depicts a front view of an inflatable compression sleeve 700, when deflated, according to some embodiments. Compression sleeve 700 is similar to compression sleeve 200 but differs therefrom that the air inlets thereof are located proximately to a left flap thereof, whereas in compression sleeve 200 air inlets 228a-228c are located proximately to the right flap of compression sleeve 200 (that is to say, first flap 204).

A first side edge 756 and a second side edge 758 of compression sleeve 700 are defined by the right and left edges, respectively, of compression sleeve 700.

Compression sleeve 700 includes a sleeve central portion 702, a first flap 704, and a second flap 706. Sleeve central portion 702 is bordered on the sides thereof by flaps 704 and 706. Flaps 704 and 706 may be removably fastened onto one another, such as to allow securing compression sleeve 700 about a limb of a subject.

Sleeve central portion 702 includes a plurality of pockets 710. According to some embodiments, and as depicted in FIG. 7, plurality of pockets 710 includes three pockets: a first pocket 710a, a second pocket 710b, and a third pocket 710c. Pockets 710a and 710b include pocket main portions 744a and 744b, respectively. Pockets 710a and 710b are fingered, further including pocket extensions 742a and 742b, respectively.

Pocket main portion 744a is adjacent to, and located above, pocket main portion 744b. Pocket main portion 744b is adjacent to, and located above, pocket 710c.

Pocket extensions 742a and 742b extend substantially downwards from pocket main portions 744a and 744b, respectively. Pocket extension 742a is bordered on the sides thereof by second flap 706 and second pocket 710b, respectively.

Air inlets 728a-728c are located in pockets 710a-710c, respectively, with air inlets 728a and 728b being located in pocket extensions 742a and 742b, respectively. Each of pockets 728a and 728b includes a spacer, similar to spacer 318a, essentially as described with respect to the fingered pockets of compression sleeve 200. Pocket extension 710a includes a spacer 718a and pocket extension 710b includes a spacer 718b. In particular, each spacer extends along the respective pocket extension at least along the region of the pocket extension wherein the respective air inlet is located. Similarly to air inlets 228a-228c of compression sleeve 200, air inlets 728a-728c are also configured to be connected to a single connector.

According to some embodiments, regions in compression sleeve 700 which do not include pockets 710a-710c (e.g. first flap 704) include ventilation holes 760, similar to ventilation holes 360.

According to some embodiments, sleeve central portion 702 is five-layered (i.e. includes five thin layers), essentially as described with respect to sleeve central portion 202 of compression sleeve 200. In such embodiments, compression sleeve 700 includes an extended spacer 750, similar to extended spacer 350 of compression sleeve 200. Extended spacer 750 includes spacers 718a and 718b. According to some such embodiments, second flap 706 is also five-layered, essentially as described with respect to second flap 206 of compression sleeve 200.

According to some embodiments, all, or substantially all, of the outer surface of sleeve central portion 702 is made of loop EVA or the like. According to some embodiments, all, or substantially all, of the outer surface of compression sleeve 700 is made of loop EVA or the like.

The positioning of air inlets 728a-728c proximately to (i.e. near) second flap 706 may contribute to the comfort of a subject and thereby help increase subject compliance. More precisely, when wrapped about a limb of the subject, first flap 704 may be located underneath the left half of sleeve central portion 702 such that—in contrast to when the air inlets are located proximately to the right flap—an extra layer (i.e. first flap 704) is present between the limb and the air inlets. The extra layer provides extra padding between the air inlets (which may be rigid) and the limb, thereby potentially contributing to the comfort of the subject.

According to some embodiments, not depicted in the figures, compression sleeve 700 does not include first flap 704 (but includes second flap 706).

According to some embodiments, compression sleeve 700 is configured to be worn about a lower leg of a subject. According to some embodiments, compression sleeve 700 is configured to be worn about an upper arm of a subject.

According to some embodiments of the disclosed compression sleeves, the compression sleeves are disposable.

According to some embodiments of the disclosed compression sleeves, the compression sleeves are washable and reusable.

According to an aspect of some embodiments, not depicted in the figures, there is provided an inflatable compression sleeve. The compression sleeve is similar to compression sleeve 200 (or to compression sleeve 500, or to compression sleeve 600, or to compression sleeve 700) but differs therefrom in not including a spacer(s). The internal layers of the first wall and second wall of each pocket are configured not to adhere to one another. For example, the internal layers may be non-smooth polymeric (e.g. PE) sheets (i.e. each polymeric sheet having a roughly textured surface) or the like, thereby helping to prevent adhesion of the polymeric sheets to one another in the pocket extensions and resultant air blockages.

According to an aspect of some embodiments, not depicted in the figures, there is provided an inflatable compression sleeve. The compression sleeve is similar to compression sleeve 100 but differs therefrom in that the outer surface of the sleeve central portion is made of loop EVA or the like. According to some embodiments, the compression sleeve further differs from compression sleeve 100 in including only three pockets (instead of four).

Although certain aspects of the invention have been exemplified in the context of treating DVT in a lower leg of a subject, it will be readily appreciated by the skilled person that these same aspects may also be of relevance in treating DVT in other limbs, other than a lower leg, such as an upper arm.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

1-38. (canceled)

39. An inflatable compression sleeve for performing compression therapy on a limb of a subject, the compression sleeve comprising a plurality of inflatable pockets, each extending substantially transversely;
wherein each of the pockets is adjacent to at least one other pocket from the plurality of pockets;
wherein each of the pockets respectively comprises a first wall, a second wall opposite to the first wall, and an air inlet, each of the first walls and the second walls being airtight, each of the second walls being adjacent to the limb when the compression sleeve is wrapped about the limb; and
wherein at least one of the pockets is fingered, comprising a pocket extension projecting substantially longitudinally from a pocket main portion of the respective pocket, the pocket extension comprising the respective air inlet.

40. The inflatable compression sleeve of claim 39, wherein the pocket extensions and the air inlets are configured such as to allow connecting the air inlets to a single connector of an inflating device.

41. The inflatable compression sleeve of claim 40, wherein the air inlets are aligned, thereby facilitating connection thereof to a single connector.

42. The inflatable compression sleeve of claim 39, wherein at least two of the pockets are fingered, wherein each of the pocket extensions is adjacent to at least one other of the pocket extensions.

43. The inflatable compression sleeve of claim 42, wherein all of the pocket extensions project substantially downwards or wherein the pocket extensions alternately project upwards and downwards.

44. The inflatable compression sleeve of claim 40, wherein the air inlets are arranged asymmetrically, and/or at least one of the air inlets comprises an asymmetrical feature, such as to allow connection to a matching asymmetrical connector only in a single orientation of the asymmetrical connector.

45. The inflatable compression sleeve of claim 39, wherein the first wall of each pocket is connected to the second wall of the pocket along a respective at least one airtight seam.

46. The inflatable compression sleeve of claim 39, further comprising a first flap and a second flap extending from two side edges, respectively, of a sleeve central portion, the sleeve central portion comprising the pockets, the flaps being configured to fasten onto one another and thereby allow fastening the compression sleeve about a limb of a subject.

47. The inflatable compression sleeve of claim 46, wherein an outer surface of the first flap comprises loop PE, loop EVA, loop PVC, or loop TPU, and wherein an inner surface of the second flap comprises hook PE, hook EVA, hook PVC, or hook TPU, respectively.

48. The inflatable compression sleeve of claim 39, wherein the first wall comprises a first wall internal layer and a first wall external layer, wherein the second wall comprises a second wall internal layer and a second wall external layer, and wherein the first wall internal layer and the second wall internal layer are made of airtight materials.

49. The inflatable compression sleeve of claim 39, wherein regions in the compression sleeve, which do not comprise the pockets, comprise ventilation holes and/or wherein the first flap comprises ventilation holes.

50. The inflatable compression sleeve of claim 39, wherein each pocket, which is fingered, further comprises a respective spacer in the form of a thin layer between the respective first wall and second wall, at least a part of the spacer being located in the respective pocket extension and being configured to prevent adherence at the pocket extension of the respective first wall and the respective second wall to the spacer.

51. The inflatable compression sleeve of claim 50, wherein each of the spacers is non-smooth and/or wherein each of the spacers is a net and/or is made of non-stick material.

52. The inflatable compression sleeve of claim 48, wherein the sleeve central portion comprises five layers:
an outer sheet of porous material comprising the first wall external layers;
a first airtight sheet comprising the first wall internal layers;
an extended spacer which comprises the spacers and which extends along at least a part of the sleeve central portion;
a second airtight sheet comprising the second wall internal layers; and
a non-woven garment comprising the second wall external layers;
wherein the five layers are disposed on one another and are connected such as to define the pockets.

53. The inflatable compression sleeve of claim 52, and wherein the first flap is also five layered.

54. The inflatable compression sleeve of claim 39, wherein the first wall and second wall are configured not to adhere to one another.

55. The inflatable compression sleeve of claim 54, wherein an internal layer of the first wall and an internal layer of the second wall, opposite to the internal layer of the first wall, are non-smooth.

56. The inflatable compression sleeve of claim 39, wherein, when the inflatable compression sleeve is worn about a limb of a subject with at least one of the plurality of pockets being inflated, the second wall of the inflated pocket compresses a part of the limb, adjacent thereto.

57. The inflatable compression sleeve of claim 39, wherein each pocket extension has a respective width at a respective location of the respective air inlet measuring no more than three times a width of the air inlet.

58. The inflatable compression sleeve of claim 39, wherein each pocket extension projects from a respective transverse edge of the respective pocket main portion at an angle no greater than 30° relative to an axis normal to the transverse edge.

59. An inflatable compression sleeve for performing compression therapy on a limb of a subject, the sleeve comprising a plurality of inflatable pockets extending substantially transversely along the sleeve;
wherein each of the pockets is adjacent to at least one other pocket from the plurality of pockets;
wherein each of the pockets respectively comprises an airtight first wall, an airtight second wall opposite to the first wall, and an air inlet, each of the second walls being adjacent to the limb when the compression sleeve is wrapped about the limb; and
wherein at least one of the pockets further comprises a spacer configured to prevent adherence thereto of the respective first wall and the respective second wall, at least a part of the spacer being located between a first wall region of the respective first wall and a second wall region of the respective second wall, the first wall region comprising the respective air inlet.
